(19) United States
(12) Patent Application Publication
(10) Pub. No.: US 2011/0164227 A1
(43) Pub. Date: Jul. 7, 2011

(54) Optical system for a digital light projection system including a multi-light path lens

(76) Inventors: Dongha Kim, Youngin-City (KR); James F. Shanley, Westborough, MA (US)

(21) Appl. No.: 12/655,794

(22) Filed: Jan. 6, 2010

(51) Int. Cl. G03B 21/28

(52) U.S. Cl. 353/98

(57) ABSTRACT

An optical system for a digital light projection system is provided. The optical system comprises an illumination source that generates unmodulated light. The optical system also comprises a multi-light path lens that receives the unmodulated light, wherein the multi-light path lens includes at least one reflective surface that reflects the unmodulated light. The optical system further comprises a modulator that receives the reflected unmodulated light, whereby the modulator generates modulated light. The multi-light path lens receives the modulated light. The multi-light path lens is used within both the unmodulated light path and the modulated light path. In other words, the multi-light path lens is used within both the illumination optical path and the imaging optical path to thereby provide an extremely compact optical system.

### FIELD OF THE INVENTION

The present invention relates generally to the field of digital light projection systems, and, more specifically, to optical systems for digital light projection systems including a multi-light path lens.

### BACKGROUND OF THE INVENTION

For digital light projection (DLP) systems, a need exists for an optical system capable of performing exceptionally by providing a reduced number of optical elements to thereby decrease manufacturing costs, parts costs, maintenance costs, and size of the optical system, and therefore the overall DLP system. Traditional optical systems for DLP systems (such as, for example, U.S. Pat. No. 6,439,726 issued to Piehler and U.S. Pat. No. 6,801,362 issued to Brown) typically include separate optical elements (e.g. lenses and mirrors) for each of the illumination optical path and the imaging optical path. However, these traditional optical systems suffer from drawbacks such as, for example, high parts costs, high maintenance costs, large required footprint, and increased optical element alignment issues. Moreover, the high design complexity of these traditional optical systems require complicated and expensive procedures and techniques to manufacture the optical systems.

Thus, it is desirable to provide an optical system which is able to overcome the above disadvantages and which can be manufactured in an inexpensive and efficient fashion.

It is therefore desirable to provide an optical system including multi-light path lenses that can be utilized in DLP systems, and that does not suffer from the above drawbacks experienced by traditional optical systems. Additionally, while addressing these problems, the optical system including multi-light path lenses of the present invention will simultaneously provide superior compact design, low parts costs, low maintenance costs, decreased optical element alignment issues, and ease of manufacturing desired in DLP systems.

These and other advantages of the present invention will become more fully apparent from the detailed description of the invention hereinbelow.

### SUMMARY OF THE INVENTION

The present invention is directed to an optical system for a digital light projection system. The optical system comprises an illumination source that generates unmodulated light. The optical system also comprises a multi-light path lens that receives the unmodulated light, wherein the multi-light path lens includes at least one reflective surface that reflects the unmodulated light. The optical system further comprises a modulator that receives the reflected unmodulated light, whereby the modulator generates modulated light. The multi-light path lens receives the modulated light. The multi-light path lens is used within both the unmodulated light path and the modulated light path. In other words, the multi-light path lens is used within both the illumination optical path and the imaging optical path to thereby provide an extremely compact optical system.

### BRIEF DESCRIPTION OF THE DRAWINGS

For the present invention to be clearly understood and readily practiced, the present invention will be described in conjunction with the following figures, wherein:

FIG. 1 is an isometric view of an exemplary digital light projection (DLP) system including a multi-light path lens, in accordance with a preferred embodiment of the present invention.

FIG. 2 is a plan view of the digital light projection system shown in FIG. 1.

FIG. 3 is a plan view of an optical system portion of an exemplary digital light projection system similar to that shown in FIG. 1, including a multi-light path lens and reflective digital imaging device (modulator), in accordance with a preferred embodiment of the present invention.

FIG. 4 is a plan view of the optical system portion shown in FIG. 3, including exemplary light ray traces.

FIG. 5 is an isometric view of an exemplary multi-light path lens and modulator, in accordance with a preferred embodiment of the present invention.

FIG. 6 is an isometric view of the multi-light path lens and modulator shown in FIG. 5.

FIG. 7 is a schematic plan view of an exemplary optical system including an illumination/light source, multi-light path lens, modulator, and post-multi-light path lens imaging optics (exit optics), in accordance with a preferred embodiment of the present invention.

FIG. 8 is a schematic plan view of an exemplary optical system including an illumination/light source, illumination optics, multi-light path lens, optics between the multi-light path lens and modulator (intermediary optics), modulator, and exit optics, in accordance with a preferred embodiment of the present invention.

FIG. 9 is a schematic plan view of an exemplary optical system including an illumination/light source, multi-light path lens, reflector, intermediary optics, modulator, and exit optics, in accordance with a preferred embodiment of the present invention.

### DETAILED DESCRIPTION OF THE PREFERRED EMBODIMENTS

It is to be understood that the figures and descriptions of the present invention may have been simplified to illustrate elements that are relevant for a clear understanding of the present invention, while eliminating, for purposes of clarity, other elements found in a typical digital light projection system. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

For purposes of this disclosure, the phrase “multi-light path lens” is hereby defined as a lens element that functions as both part of (or the entirety of) the illumination optics and part of (or the entirety of) the imaging optics.

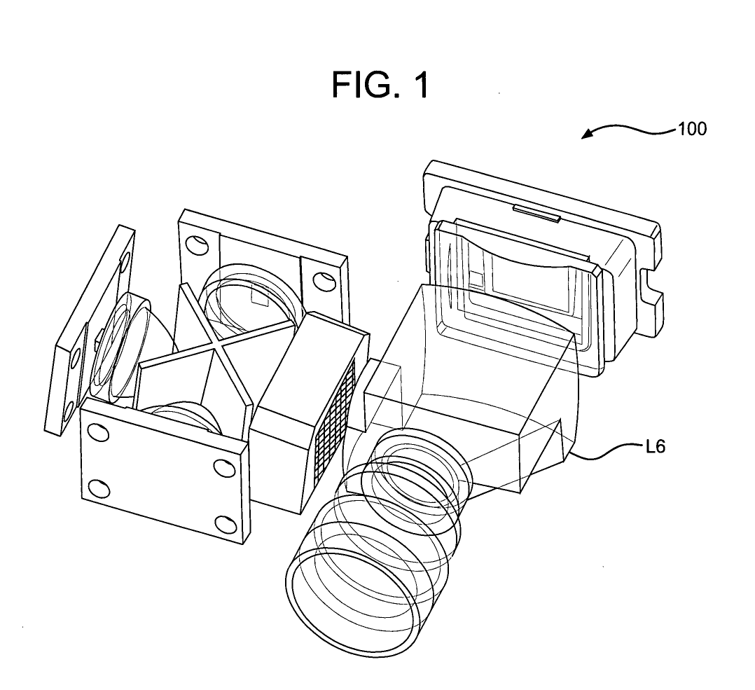

FIG. 1 is an isometric view of an exemplary digital light projection (DLP) system 100 including a multi-light path (MLP) lens L6, in accordance with a preferred embodiment of the present invention. For simplicity purposes, only the MLP lens L6 in DLP system 100 is labeled.

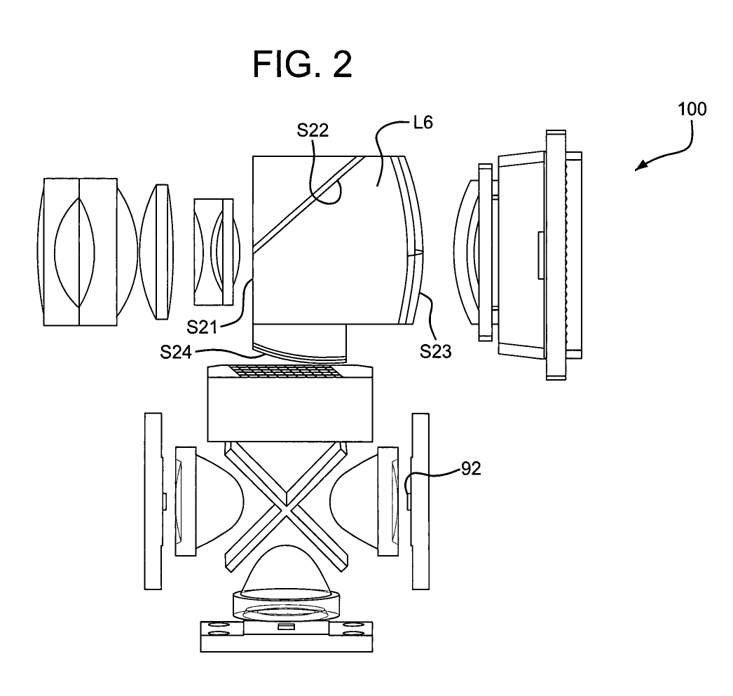

FIG. 2 is a plan view of the digital light projection system 100 shown in FIG. 1. For simplicity purposes, only the MLP lens L6 (including surfaces S21, S22, S23, S24) in DLP system 100 is labeled.

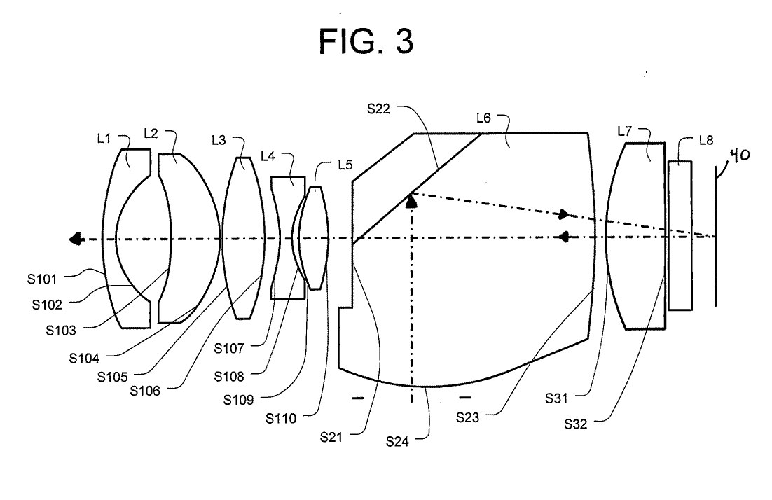

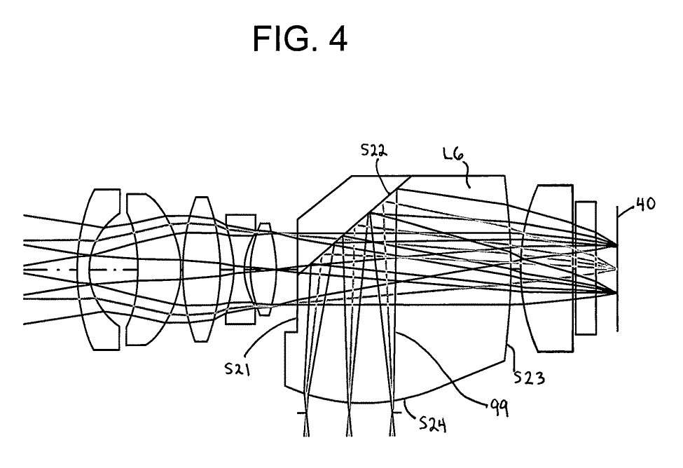

FIG. 3 is a plan view of an optical system portion of an exemplary digital light projection system similar to that shown in FIG. 1, including a multi-light path lens L6 and reflective digital imaging device (modulator) 40, in accordance with a preferred embodiment of the present invention. FIG. 3 also illustrates lenses L1-L5 (including surfaces S101-S110), MLP lens L6 (including surfaces S21, S22, S23, S24), and lenses L7, L8 (including surfaces S31, S32). Modulator 40 is also illustrated in FIG. 3. FIG. 4 is a plan view of the optical system portion shown in FIG. 3, including exemplary light ray traces 99.

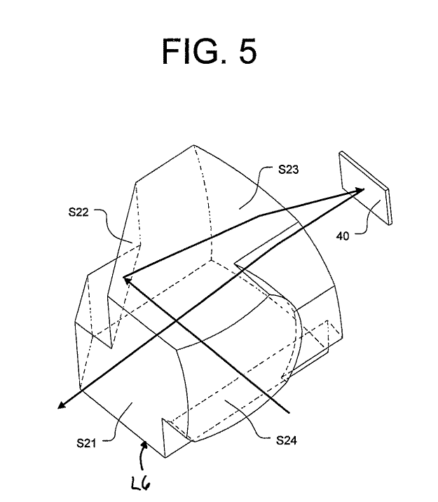

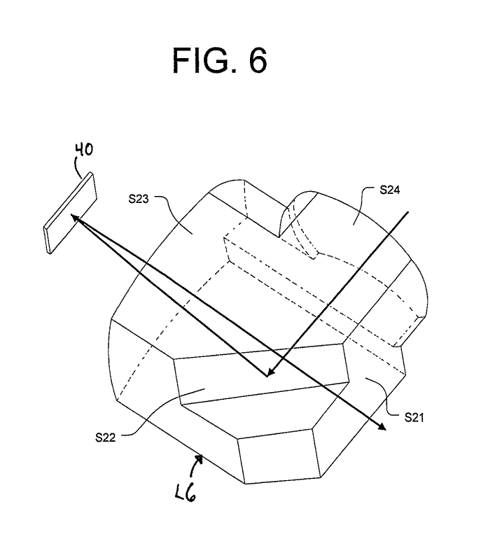

FIG. 5 is an isometric view of an exemplary multi-light path lens L6 and modulator 40, in accordance with a preferred embodiment of the present invention. FIG. 6 is another isometric view of the multi-light path lens L6 and modulator 40 shown in FIG. 5.

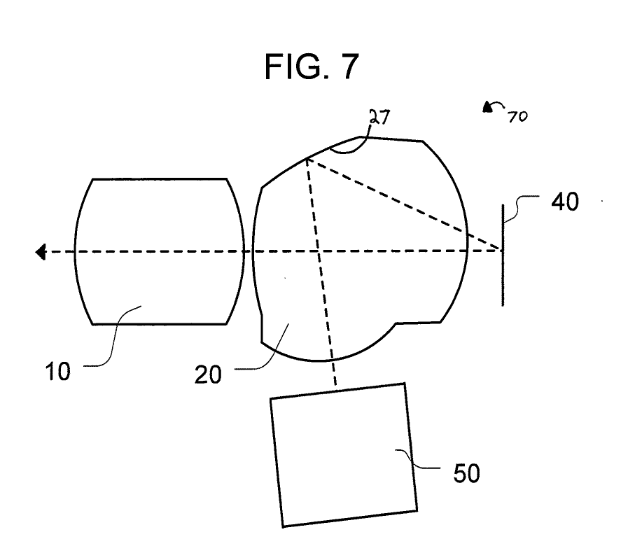

FIG. 7 is a schematic plan view of an exemplary optical system 70 including an illumination/light source 50, multi-light path lens 20, reflective surface 27, modulator 40, and post-multi-light path lens imaging optics (exit optics) 10, in accordance with a preferred embodiment of the present invention.

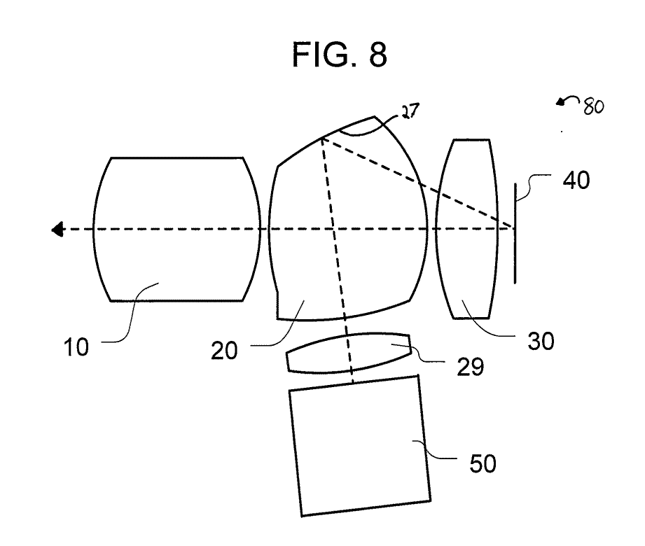

FIG. 8 is a schematic plan view of an exemplary optical system 80 including an illumination/light source 50, illumination optics 29, multi-light path lens 20, reflective surface 27, optics between the multi-light path lens and modulator (intermediary optics) 30, modulator 40, and exit optics 10, in accordance with a preferred embodiment of the present invention.

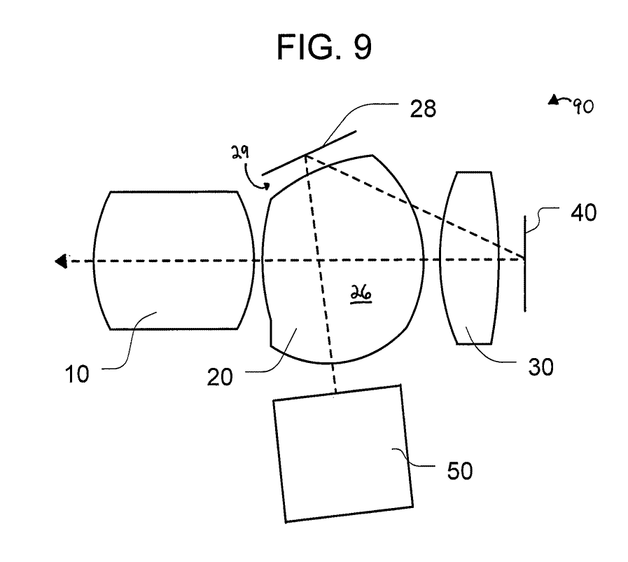

FIG. 9 is a schematic plan view of an exemplary optical system 90 including an illumination/light source 50, multi-light path lens 20, reflector 28, intermediary optics 30, modulator 40, and exit optics 10, in accordance with a preferred embodiment of the present invention.

The present invention is directed to an optical system 70, 80, 90 for a digital light projection system 100. The optical system comprises an illumination source 50 that generates unmodulated light. The optical system also comprises a multi-light path lens 20 that receives the unmodulated light, wherein the multi-light path lens includes at least one reflective surface S22, 27, 28 that reflects the unmodulated light. The optical system further comprises a modulator 40 that receives the reflected unmodulated light, whereby the modulator generates modulated light. The multi-light path lens receives the modulated light. The multi-light path lens is used within both the unmodulated light path and the modulated light path. In other words, the multi-light path lens is used within both the illumination optical path and the imaging optical path to thereby provide an extremely compact optical system.

The multi-light path lens 20 may comprise any optically transparent material such as plastic, glass, polymer, cyclic olefins, polycarbonates, or combinations thereof, for example, Zeonex®. Some or all of surfaces S21-S24 may be curved (e.g. spherical or aspherical). Alternatively, surface S22 may comprise Fresnel steps or facets.

The illumination source 50 may preferably comprise at least one LED 92 (FIG. 2). The at least one LED may be provided in either singular or array form. In array form, each LED array may comprise single color or multi-color LEDs. The illumination source may alternatively comprise another light source such as at least one laser.

The modulator may preferably comprise a DMD, but another reflective digital imaging device may alternatively be employed.

The optical system of claim 1, wherein the reflective surface S22, 27 of the multi-light path lens is a total internal reflective surface that totally internally reflects the unmodulated light.

The optical system of claim 1, wherein the reflective surface S22, 27 of the multi-light path lens is a specular reflective surface that specularly reflects the unmodulated light.

The optical system of claim 1, wherein the reflective surface S22, 27 of the multi-light path lens may be curved.

The optical system of claim 1, wherein the multi-light path lens receives the unmodulated light through an entrance surface S24 which may be curved.

The optical system of claim 1, wherein the reflective surface S22, 27 of the multi-light path lens reflects the unmodulated light towards the modulator through an intermediary surface S23. The intermediary surface may be curved. The reflected unmodulated light and the modulated light are transmitted through the intermediary surface S23.

The optical system of claim 9, wherein the reflected unmodulated light and the modulated light are transmitted through the intermediary surface S23 via surface portions that follow substantially the same surface shape equation.

The optical system of claim 1, wherein the modulated light received by the multi-light path lens exits the multi-light path lens through an exit surface S21 which may be curved. The modulated light passing through exit surface S21 is transmitted towards a screen or wall (not shown) for display of the projected image or video.

The optical system of claim 1, wherein the multi-light path lens receives the unmodulated light via illumination optics 29 provided between the illumination source 50 and the multi-light path lens 20.

The optical system of claim 1, wherein the reflected unmodulated light and the modulated light are transmitted through intermediary optics 30 provided between the multi-light path lens 20 and the modulator 40.

The optical system of claim 1, wherein a gap 29 (FIG. 9) is provided between the reflective surface 28 of the multi-light path lens 20 and a main body portion 26 of the multi-light path lens 20.

In the present invention, the multi-light path lens 20 is used within both the unmodulated light path and the modulated light path. In other words, the multi-light path lens is used within both the illumination optical path and the imaging optical path to thereby provide an extremely compact, consolidated optical system. This is in significant contrast to the above-mentioned prior art optical systems in U.S. Pat. Nos. 6,439,726 and 6,801,362 which utilize completely separate optical elements for each of the illumination optical path and the imaging optical path, thereby providing excess and/or redundant optical elements and correspondingly wasted space. This non-consolidated prior art approach has significant drawbacks as mentioned in the “Background Of The Invention” section above, wherein the advantages of the present invention optical system are also explained. As such, the present invention accomplishes a consolidated optical system configuration by reducing/consolidating the number of optical elements (and corresponding spacing) typically employed in prior art optical systems.

Instead of comprising lenses, the elements within the illumination and imaging optical paths (excluding the multi-light path lens) each may alternatively comprise a refractive element, a reflective element (e.g. mirror), a diffractive element, or combinations thereof. The surface shapes for surfaces S21-S24 (and the remain lens surface within the overall optical system) may be provided in whole, or in part, by Fresnel steps or facets. It may be desirable to provide additional mirror elements to effect additional folds in the optical path of the optical system to thereby reduce the overall dimensions of the housing containing the DLP system 100.

The DLP system 100 of the present invention may be employed as a free-standing or hand-held projector (i.e. without a screen), or alternatively may be employed in conjunction with a screen.

The contemplated modifications and variations specifically mentioned above and below are considered to be within the spirit and scope of the present invention.

Those of ordinary skill in the art will recognize that various modifications and variations may be made to the embodiments described above without departing from the spirit and scope of the present invention. For example, the shape, size, and/or composition of each of the surfaces S21-S24 may be different than what is described above or shown in the drawings and each is dependent on the design of the overall optical system. Moreover, illumination optics 29 (which may include, for example, a light pipe and/or fly-eye lens), intermediary optics 30, and exit optics 10 are each to be considered optional optical elements. Their use, omission, number of components, size, composition, and/or shapes are dependent on the design of the multi-light path lens and overall optical system. It is therefore to be understood that the present invention is not limited to the particular embodiments disclosed above, but it is intended to cover such modifications and variations as defined by the following claims.

What is claimed is:

1. An optical system for a digital light projection system, the optical system comprising:
an illumination source that generates unmodulated light;
a multi-light path lens that receives the unmodulated light, wherein the multi-light path lens includes at least one reflective surface that reflects the unmodulated light; and
a modulator that receives the reflected unmodulated light, whereby the modulator generates modulated light;
wherein the multi-light path lens receives the modulated light.

2. The optical system of claim 1, wherein the illumination source comprises at least one LED.

3. The optical system of claim 1, wherein the illumination source comprises at least one laser.

4. The optical system of claim 1, wherein the modulator is a DMD.

5. The optical system of claim 1, wherein the reflective surface of the multi-light path lens is a total internal reflective surface that totally internally reflects the unmodulated light.

6. The optical system of claim 1, wherein the reflective surface of the multi-light path lens is a specular reflective surface that specularly reflects the unmodulated light.

7. The optical system of claim 1, wherein the reflective surface of the multi-light path lens is curved.

8. The optical system of claim 1, wherein the multi-light path lens receives the unmodulated light through an entrance surface which is curved.

9. The optical system of claim 1, wherein the reflective surface of the multi-light path lens reflects the unmodulated light towards the modulator through an intermediary surface.

10. The optical system of claim 9, wherein the intermediary surface is curved.

11. The optical system of claim 9, wherein the reflected unmodulated light and the modulated light are transmitted through the intermediary surface.

12. The optical system of claim 9, wherein the reflected unmodulated light and the modulated light are transmitted through the intermediary surface via surface portions that follow substantially the same surface shape equation.

13. The optical system of claim 1, wherein the modulated light received by the multi-light path lens exits the multi-light path lens through an exit surface which is curved.

14. The optical system of claim 1, wherein the multi-light path lens receives the unmodulated light via illumination optics provided between the illumination source and the multi-light path lens.

15. The optical system of claim 1, wherein the reflected unmodulated light and the modulated light are transmitted through intermediary optics provided between the multi-light path lens and the modulator.

16. The optical system of claim 1, wherein a gap is provided between the reflective surface of the multi-light path lens and a main body portion of the multi-light path lens.
